(19) United States
(12) Patent Application Publication
(10) Pub. No.: US 2003/0194099 A1
(43) Pub. Date: Oct. 16, 2003

(54) Method and apparatus for processing microphone audio signals

(75) Inventors: Wei-Hung Huang, Hsinchu City (TW); Po-Wen Ku, Hsinchu City (TW)

Correspondence Address: BRINKS HOFER GILSON & LIONE, P.O. BOX 10395, CHICAGO, IL, 60611, US

(73) Assignee: MEDIA TEK INC.

(21) Appl. No.: 10/120,459

(22) Filed: Apr. 11, 2002

(51) Int. Cl. H04R 3/00

(52) U.S. Cl. 381/111; 381/92; 381/122

(57) ABSTRACT

In a method and apparatus for processing a microphone audio signal, the microphone audio signal is converted into an initial digital signal at a first sampling frequency. The initial digital signal is stored in a memory at a second sampling frequency lower than the first sampling frequency. The initial digital signal stored in the memory is processed so as to result in a processed digital signal. The processed digital signal is outputted at an output frequency equal to the first sampling frequency. The initial digital signal and the processed digital signal are combined to result in a composite digital signal. Finally, the composite digital signal is converted into an analog processed audio signal output.

### BACKGROUND OF THE INVENTION

1. Field of the Invention

The invention relates to a method and apparatus for processing an audio signal, more particularly to a method and apparatus for processing a microphone audio signal.

2. Description of the Related Art

FIG. 1 illustrates a conventional apparatus 3 for processing an audio signal from a microphone 1 so as to produce an audio signal output that can be reproduced by a loudspeaker 2. The apparatus 3 includes an analog-to-digital converter 31, a memory 32, a digital signal processor 33, and a digital-to-analog converter 34. The analog-to-digital converter 31 converts the audio signal from the microphone 1 into an initial digital signal at a sampling frequency. The memory 32 is coupled electrically to the analog-to-digital converter 31 for storing the initial digital signal therein. The digital signal processor 33 is coupled electrically to the memory 32, and processes the initial digital signal stored in the memory 32 to result in a processed digital signal in accordance with a desired sound effect, such as echo, chorus, flanger, pitch shift, equalizer, etc. The digital-to-analog converter 34 is coupled electrically to the digital signal processor 3, and converts the processed digital signal therefrom into an analog processed audio signal output this is provided to the loudspeaker 2.

Generally, a digital signal converted from an analog audio signal at a higher sampling frequency will result in a high quality audio output. As such, when increasing the sampling frequency, storage capacity for the memory 32 and instruction processing capability for the digital signal processor 33 need to be enhanced accordingly. For example, the required storage capacity for the memory 32 during echo processing depends on maximum delay time, a sampling frequency and the number of storage bits for each sampling. If the maximum delay time is 300 ms, the sampling frequency is 48000 Hz, and the number of storage bits is 16, the required storage capacity for the memory 32 is 28800 bytes (i.e., 0.3×48000×16=230400 bits=28800 bytes). Therefore, in order to obtain a high quality output, the conventional apparatus 3 requires a relatively large circuit overhead such that the conventional apparatus 3 is difficult to be built into an integrated circuit chip.

### SUMMARY OF THE INVENTION

Therefore, the object of the present invention is to provide a method and apparatus for processing a microphone audio signal, which can reduce memory capacity and operating capability requirements.

According to one aspect of the present invention, a method for processing a microphone audio signal comprises the steps of:

(a) converting the microphone audio signal into an initial digital signal at a first sampling frequency;

(b) storing the initial digital signal in a memory at a second sampling frequency lower than the first sampling frequency;

(c) processing the initial digital signal stored in the memory to result in a processed digital signal;

(d) outputting the processed digital signal at an output frequency equal to the first sampling frequency;

(e) combining the initial digital signal and the processed digital signal obtained in step (d) to result in a composite digital signal; and

(f) converting the composite digital signal into an analog processed audio signal output.

According to another aspect of the present invention, an apparatus for processing a microphone audio signal comprises:

an analog-to-digital converter for converting the microphone audio signal into an initial digital signal at a first sampling frequency;

a memory coupled electrically to the analog-to-digital converter;

a processor coupled electrically to the memory, the processor controlling the memory to store the initial digital signal therein at a second sampling frequency lower than the first sampling frequency, the processor processing the initial digital signal stored in the memory to result in a processed digital signal, the processor outputting the processed digital signal at an output frequency equal to the first sampling frequency;

a combiner, coupled electrically to the analog-to-digital converter and the processor, for combining the initial digital signal from the analog-to-digital converter and the processed digital signal from the processor to result in a composite digital signal; and

a digital-to-analog converter, coupled electrically to the combiner, for converting the composite digital signal into an analog processed audio signal output.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a conventional apparatus for processing a microphone audio signal;

FIG. 2 is a schematic circuit block diagram illustrating the preferred embodiment of an apparatus for processing a microphone audio signal according to the present invention; and

FIG. 3 is a flow chart illustrating how the preferred embodiment processes the microphone audio signal according to the present invention.

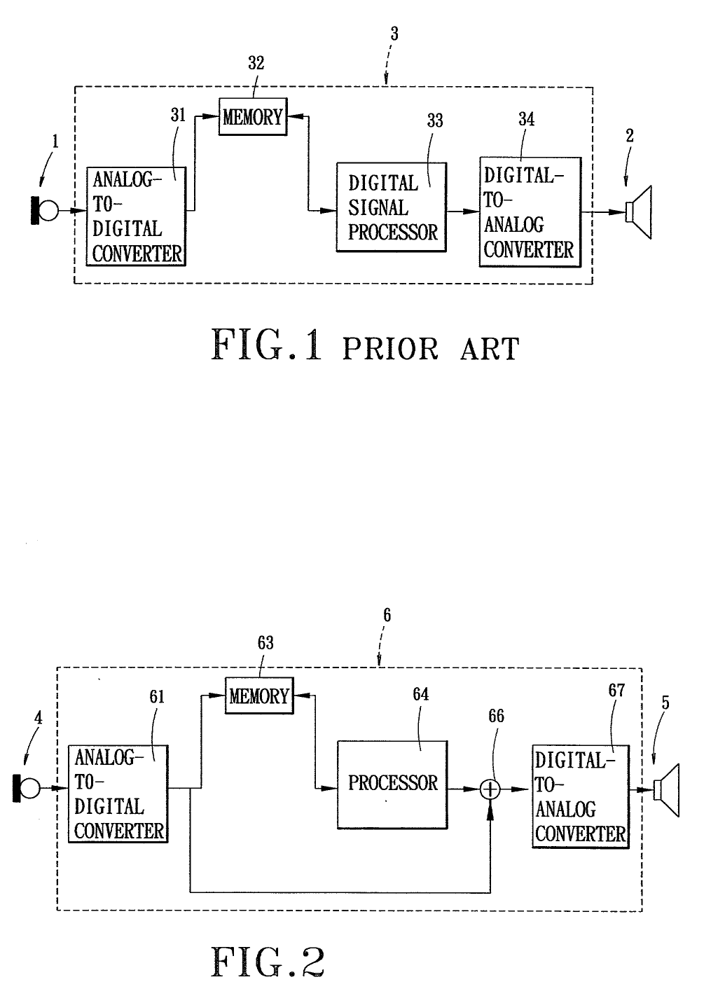

### DETAILED DESCRIPTION OF THE PREFERRED EMBODIMENT

Referring to FIG. 2, the preferred embodiment of an apparatus 6 for processing a microphone audio signal according to the present invention is shown to include an analog-to-digital converter 61, a memory 63, a processor 64, a combiner 66, and a digital-to-analog converter 67.

The analog-to-digital converter 61, which is an integrated circuit that is adapted to be coupled electrically to a microphone 4, converts the microphone audio signal into an initial digital signal at a first sampling frequency, such as 48000 Hz.

The memory 63 is coupled electrically to the analog-to-digital converter 61.

The processor 64 is coupled electrically to the memory 63, and controls the memory 63 to store the initial digital signal therein at a second sampling frequency lower than the first sampling frequency. The processor 64 processes the initial digital signal stored in the memory 63 to result in a processed digital signal. The processor 64 outputs the processed digital signal at an output frequency equal to the first sampling frequency. In this embodiment, the second sampling frequency can be greater than or equal to 8000 Hz, such as 24000 Hz or 12000 Hz, depending upon the design requirements. For example, when the maximum delay time for echo processing is 300 ms, the second sampling frequency is 24000 Hz, and the number of storage bits is 16, the required storage capacity for the memory 63 is 14400 bytes (i.e., 0.3×24000×16=115200 bits=14400 bytes), which is apparently less than that needed in the aforesaid conventional apparatus 3. Furthermore, since the second sampling frequency is lower than the first sampling frequency, less data is stored in the memory 63 such that requirement for operating capability of the processor 64 is reduced. As such, each of the memory 63 and the processor 64 can be formed on a relatively small circuit area so as to facilitate building of the same into a single integrated circuit chip.

The combiner 66, which is coupled electrically to the analog-to-digital converter 61 and the processor 64, combines the initial digital signal from the analog-to-digital converter 61 and the processed digital signal form the processor 64 to result in a composite digital signal. In this embodiment, the combiner 66 is an accumulator that is in the form of an integrated circuit.

The digital-to-analog converter 67, which is coupled electrically to the combiner 66, converts the composite digital signal into an analog processed audio signal output that can be reproduced by a loudspeaker 5.

Preferably, the analog-to-digital converter 61, the memory 63, the processor 64, the combiner 66 and the digital-to-analog converter 67 are built into a single integrated circuit chip.

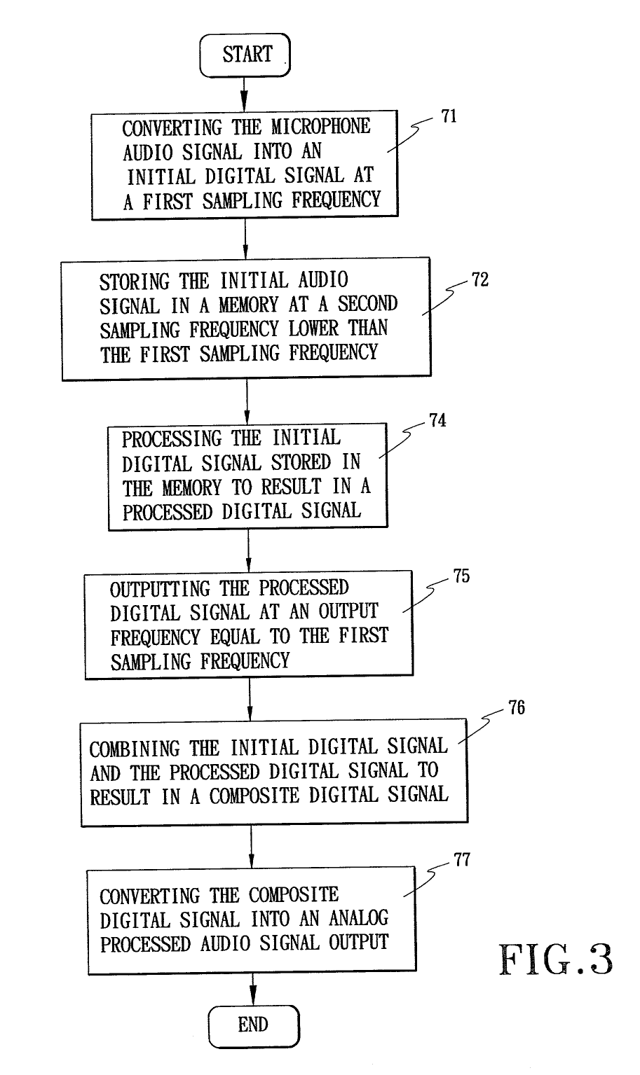

Referring to FIG. 3, there is shown a flow chart to illustrate how the apparatus 6 processes the microphone audio signal according to the present invention. In step 71, the analog-to-digital converter 61 converts the microphone audio signal into the initial digital signal at the first sampling frequency (such as 48000 Hz). In step 72, the processor 64 controls the memory 63 to store the initial digital signal therein at the second sampling frequency lower than the first sampling frequency. In step 74, the processor 64 processes the initial digital signal stored in the memory 63 to result in a processed digital signal. In step 75, the processor 64 outputs the processed digital signal at the output frequency equal to the first sampling frequency. In step 76, the combiner 66 combines the initial digital signal from the analog-to-digital converter 61 and the processed digital signal obtained in step 75 to result in the composite digital signal. In step 77, the digital-to-analog converter 67 converts the composite digital signal into the analog processed audio signal output.

To sum up, due to the use of the lower second sampling frequency, the apparatus 6 of this invention can reduce the memory capacity and operating capability requirements. Furthermore, due to the presence of the combiner 66, the quality of the analog processed audio signal output can be ensured.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for processing a microphone audio signal, comprising the steps of:
(a) converting the microphone audio signal into an initial digital signal at a first sampling frequency;
(b) storing the initial digital signal in a memory at a second sampling frequency lower than the first sampling frequency;
(c) processing the initial digital signal stored in the memory to result in a processed digital signal;
(d) outputting the processed digital signal at an output frequency equal to the first sampling frequency;
(e) combining the initial digital signal and the processed digital signal obtained in step (d) to result in a composite digital signal; and
(f) converting the composite digital signal into an analog processed audio signal output.

2. An apparatus for processing a microphone audio signal, comprising:
an analog-to-digital converter for converting the microphone audio signal into an initial digital signal at a first sampling frequency;
a memory coupled electrically to said analog-to-digital converter;
a processor coupled electrically to said memory, said processor controlling said memory to store the initial digital signal therein at a second sampling frequency lower than the first sampling frequency, said processor processing the initial digital signal stored in said memory to result in a processed digital signal, said processor outputting the processed digital signal at an output frequency equal to the first sampling frequency;
a combiner, coupled electrically to said analog-to-digital converter and said processor, for combining the initial digital signal from said analog-to-digital converter and the processed digital signal from said processor to result in a composite digital signal; and
a digital-to-analog converter, coupled electrically to said combiner, for converting the composite digital signal into an analog processed audio signal output.

3. The apparatus as claimed in claim 2, wherein each of said analog-to-digital converter, said processor, said combiner and said digital-to-analog converter is formed as an integrated circuit.

4. The apparatus as claimed in claim 3, wherein at least two of said analog-to-digital converter, said processor, said memory, said combiner and said digital-to-analog converter are built into a single integrated circuit chip.

5. The apparatus as claimed in claim 2, wherein said combiner is an accumulator.
